(19) United States
(12) Patent Application Publication
(10) Pub. No.: US 2022/0188498 A1
(43) Pub. Date: Jun. 16, 2022

(54) Method For Producing An Industrial Electrical Cabinet

(71) Applicant: SATIE SAS, Cernay (FR)

(72) Inventors: Gino FACCIN, ZIMMERSHEIM (FR); Steve JACQUEMIN, RIXHEIM (FR); Stéphane BECKER, STRASBOURG (FR); Martin KUPPE, STRASBOURG (FR); Jean-Michel STENGER, STRASBOURG (FR)

(73) Assignee: SATIE SAS, Cernay (FR)

(21) Appl. No.: 17/441,076

(22) PCT Filed: Mar. 31, 2020
(86) PCT No.: PCT/EP2020/059061

§ 371 Date: Sep. 20, 2021

(30) Foreign Application Priority Data
Apr. 1, 2019 (FR) 1903433

(51) Int. Cl. G06F 30/392; G06F 30/10; H02B 1/30

(52) U.S. Cl. CPC G06F 30/392; H02B 1/30; G06F 30/10

(57) ABSTRACT

A method for producing an industrial electrical cabinet depending on a list of electrical components includes the following five steps: extracting a representation and technical information associated with each electrical component; calculating a first installation where the grouped electrical components are juxtaposed and the remaining electrical components arranged in the free spaces of a first frame defined depending on the first installation; displaying the first installation with a mechanism for modifying the installation of each electrical component and/or the dimensions of the first frame; for each modification carried out, calculating and displaying, in dynamic mode, a new installation and/or a new frame depending on constraints applied by the user; and producing an industrial electrical cabinet depending on the obtained installation.

### TECHNICAL FIELD

The invention concerns a method for guiding a user in making an industrial electrical cabinet and for automating the steps of designing said cabinet.

More specifically, the invention concerns a computer-implemented invention wherein a graphical interface makes it possible to guide the user in defining an installation of previously defined electrical components, and wherein a software tool makes it possible to automatically design an industrial electrical cabinet depending on said installation.

The invention is of particularly advantageous application for defining and producing an industrial electrical cabinet wherein electrical components and support structures have variable geometries and multiple installation constraints.

### PRIOR ART

Unlike domestic applications for which electrical cabinets are standardised, industrial electrical cabinets must allow the integration of particular electrical components with their own dimensions and specific support structures.

In industrial electrical cabinets, the support structures often correspond to two parallel rails allowing the electrical components to be screwed or clipped with a variable spacing depending on the electrical component.

For example, some companies develop and use proprietary electrical components for specific power, control security, and/or industrial machine interface applications. Thus, for industrial electrical cabinets, electrical components of variable sizes with various functions and different support structures should be made to coexist in one same frame.

A large number of software programs aim to facilitate the creation of a domestic electrical cabinet. This is, for example, software developed by Legrand®, Schneider Electric® or Hager®, the principle of which is mentioned in publication US 2011/307100 A1.

The operation of these software is similar. The user starts by selecting the equipment that he wishes to integrate into his domestic household electrical cabinet.

Based on the selected electrical components, the software retrieves from a database a representation of each electrical component and a set of technical information, such as the nature and size of each electrical component.

Depending on the overall size of all the selected electrical components, the software can choose, from a library of predefined boxes, a useable box size and then propose an installation of the electrical components by juxtaposing the components of the same nature until one or more predefined assembly lines are filled with the selected box.

This calculation is quite simple because the electrical components have similar dimensions and, above all, the same support structures can be used to support the various electrical components. In addition, these software use a predefined and constant distance between the lines.

In the case of the installation of an industrial electrical cabinet, there is no software making it possible to carry out an automated installation because of the great variability of the electrical components and of their fixing means, nor to create in real time a custom-made electrical cabinet from this installation.

The “EPLAN Pro Panel 3D” software offers, for example, the user to manually position each element of an industrial electrical cabinet. To this end, the user works as on an industrial drawing table, and he begins by drawing his support according to his estimate of the final size of the predefined electrical components (see, for example, the following publications: “EPLAN ProPanel 3D Panel Layout Tutorial”, YouTube, 8 Jan. 2015, page 1 pp., Excerpt from the Internet; Edgar C. Tamayo et al. “Design automation of control panels for automated modular construction machines”, Procedia Cirp, vol. 70, 31 May 2018, pages 404-409).

To install the electrical components, the user seeks to group the electrical components of the same nature, i.e. the components configured to provide power, security, control and/or a connection interface for one or more devices, according to rules of good practice such as those set out, for example, in the following publication: Anonymous “Control Engineering: Four aspects of good control panel design”, 2 Jan. 2017, Excerpt from the Internet.

In these groupings, the user then groups the electrical components which have the same fixing means and similar dimensions in order to juxtapose them in one same row. The other electrical components are then arranged depending on the remaining space and the preferences of the user.

The user can thus obtain an installation of the selected electrical components. However, this installation is not necessarily optimised, and it is often possible to produce another installation which would make it possible, by virtue of laborious research into specific arrangements, to reduce the dimensions of the frame. Furthermore, the resulting installation is highly variable from one user to another.

In addition, the definition of an industrial cabinet installation is a long process which may require significant modifications depending on new constraints. For example, an electrical component may be modified during installation to meet new operating requirements.

The modification of an electrical component in a predefined installation is often a source of considerable complexity when the dimensions of the selected frame are chosen as accurately as possible, such that the user often chooses another larger frame in order to anticipate possible modifications of components, in order to reserve empty spaces in the frame for installing new electrical components and/or replacing existing electrical components.

Thus, the known processes for installing electrical components in an industrial electrical cabinet, assisted or not by a computer, include a risk of the industrial electrical cabinet being oversized in relation to needs.

The technical problem of the invention is to efficiently determine an installation of predefined electrical components to form an industrial electrical cabinet by facilitating the possibility of modifying the electrical components and limiting the dimensions of the industrial electrical cabinet.

Another technical problem of the invention consists of creating a custom-made electrical cabinet from a determined installation of the electrical components, by means of an automated, dynamic, rapid and configurable method, making it possible to obtain an unlimited number of electrical frames and cabinets, without any restriction imposed by a library of frames and/or cabinets predefined in accordance with the configurators of the state of the art.

### DISCLOSURE OF THE INVENTION

In order to overcome this technical problem, the invention proposes to provide a first automated installation depending on standard criteria and to define the dimensions of the frame after this first installation has been defined. Since this first installation carried out with standard criteria is often imperfect, the invention proposes to allow the user to impose one or more constraints in order to redo the installation depending on the constraints imposed by the user in order to refine, iteratively, the installation and to facilitate modifications of the electrical components and/or the dimensions of the frame.

To this end, the invention concerns a method for producing an industrial electrical cabinet depending on a list of electrical components, said method being implemented by computer and comprising, in order, the following steps:

extracting a representation and technical information associated with each electrical component, said technical information integrating at least one classification of said electrical component, a size of said electrical component and fixing information describing means for fixing said electrical component;
calculating a total occupancy area of said electrical components depending on said size of each electrical component;
defining a first frame depending on said total occupancy area;
grouping of said electrical components depending on said classification and said fixing information of each electrical component;
calculating a first installation wherein said grouped electrical components are juxtaposed and said remaining electrical components are iteratively arranged in the free spaces of said first frame;
displaying of said first installation with means for modifying the installation of each electrical component and/or the dimensions of said first frame;
for each modification carried out, calculating and displaying in dynamic mode of a new installation and/or of a new frame depending on the constraints applied by the user; and
producing an industrial electrical cabinet depending on said obtained installation and/or of said new frame.

The invention thus makes it possible to reconstruct, virtually and iteratively, the installation of electrical components in an industrial electrical cabinet custom-made and only after having finalised the installation of said electrical components. Although a first frame is defined in order to obtain the first installation, the constraints applied by the user in the positioning of certain electrical components and/or in the dimensions of the frame often make it possible to obtain an industrial electrical cabinet with a reduced size compared with the size of the first installation.

The reduction of size has a positive impact on the reduction of raw materials and the reduction of the manufacturing costs of both the frame and of the cabinet.

Thus, the invention proposes using a method for determining an installation of electrical components in an industrial cabinet, which is defined retrospectively, which corresponds to a design strategy that is completely reversed with respect to the state of the art.

Indeed, in the state of the art, the installation always starts with the definition of a frame or the selection of a frame from a library of predefined frame, and the entire installation strategy is carried out taking into account the dimensions of this predefined frame.

The invention aims to allow a modification of the dimensions of the frame during modifications of the installation such that the dimensions of the frame no longer constitute the starting point of the installation and it is the constraints imposed by the electrical components and by their positioning which constitute the starting point of the installation.

As a result, the invention allows to determine an optimal installation for the electrical components more efficiently.

Furthermore, the possibilities of modifications during the development process also make it possible to facilitate the replacement of existing electrical components.

Preferably, said extraction step is configured to obtain a three-dimensional representation of each electrical component such that the display of the installations is produced in three dimensions.

Although the invention can be used with two-dimensional representations, the three-dimensional representations make it possible to improve the possibilities of extracting information for the embodiment.

For example, by moving a three-dimensional model, a technician can more easily detect the positioning of screws or clips for elements that are arranged under the electrical components.

However, the three-dimensional representation induces a major constraint: the fluidity of the modification interface. Indeed, the modification is preferably applied by the user via a man-machine interface of a computing device such as a computer, a touchpad or a smartphone. The man-machine interface may be generated directly by an application installed on the user's device or hosted on a remote server.

In any case, the calculations necessary to apply the constraints of the user consume material resources and the displaying of elements in three dimensions is often too long.

To reduce these display constraints, said extraction step preferably performs a transformation of said representation into the FBX format. Indeed, electrical components are generally available in the STEP format, which is an industry standard format.

This STEP format, defined by the ISO 10303 standard, represents elements in three dimensions using a model of curves and surfaces.

However, the use of this STEP format to represent a large number of electronic components and support elements induces a calculation time that is too long to guarantee the fluidity of the interface and a rapid response in real time. This embodiment proposes to transform the representations available in STEP format into FBX format.

The data of this format can be represented in binary or ASCII form and describe a hierarchy of blocks or nodes having identifiers as well as properties of different types: integer, decimal, character string, table, etc.

This FBX format is mainly used in the field of video games and the transformation from STEP format to FBX format results in a loss of information in the definition of the representations of the electronic components and the support elements which seems incompatible with the intended application.

However, it has been observed that this loss of information is acceptable with regard to the gain in performance obtained by using this FBX format, which is very specific and used in an unprecedented manner to represent an installation of an industrial electrical cabinet.

Furthermore, to host the online application and to be able to access it from an internet interface with great fluidity, on any type of computer device such as a computer, touchpad or smartphone, it is necessary to use a format other than STEP or FBX formats. One embodiment of the invention proposes to use the AssetBundle format. This AssetBundle format is specific to the use of the Unity three-dimensional engine and allows serialisation, LZ4 type compression as well as streaming of objects archived in this format. Preferably, this conversion is automated and is performed on a dedicated server. It makes it possible to serve optimised data to the application quickly, in real time, and combines a low cost in memory unlike a raw loading of the FBX format.

Further to the dedicate formats, complementary embodiment of the invention proposes to limit the technical information associated with the electrical components in order to improve fluidity.

According to this embodiment, said technical information comprises only a reference of said electrical component, a classification of said electrical component, a size of said electrical component and a fixing information describing means for fixing said electrical component.

According to one embodiment, said step of defining a first frame is performed by creating a frame, the depth of which is greater than the maximum depth of the electrical components.

According to one embodiment, said step of defining a first frame depending on said total occupancy area is performed by creating a frame, the area of which is greater than the total occupancy area multiplied by a coefficient of between 1.2 and 1.5, preferably 1.3.

According to one embodiment, said step of grouping said electrical components is performed according to four functions: securing, powering, controlling, and interfacing one or more devices.

According to one embodiment, said calculation step seeks, firstly, to mount the electrical components grouped together on profiles mounted on stirrups themselves mounted on support uprights and, secondly, on rails mounted on support uprights.

### BRIEF DESCRIPTION OF THE FIGURES

Other characteristics and advantages of the invention will become apparent from the description below, given by way of non-limiting illustration, and made with reference to the accompanying drawings, wherein:

FIG. 1 is a flowchart of the steps of making an industrial electrical cabinet according to one embodiment of the invention;

FIG. 2 is a flowchart detailing an example of a calculation of the installation of FIG. 1;

FIG. 3 illustrates a perspective view of a first installation obtained by the steps of FIG. 1;

FIG. 4 illustrates a perspective view of a second installation obtained by the steps of FIG. 1;

FIG. 5 illustrates a perspective view of a third installation obtained by the steps of FIG. 1; and

FIG. 6 illustrates a perspective view of a fourth installation obtained by the steps of FIG. 1.

### DETAILED DESCRIPTION OF THE INVENTION

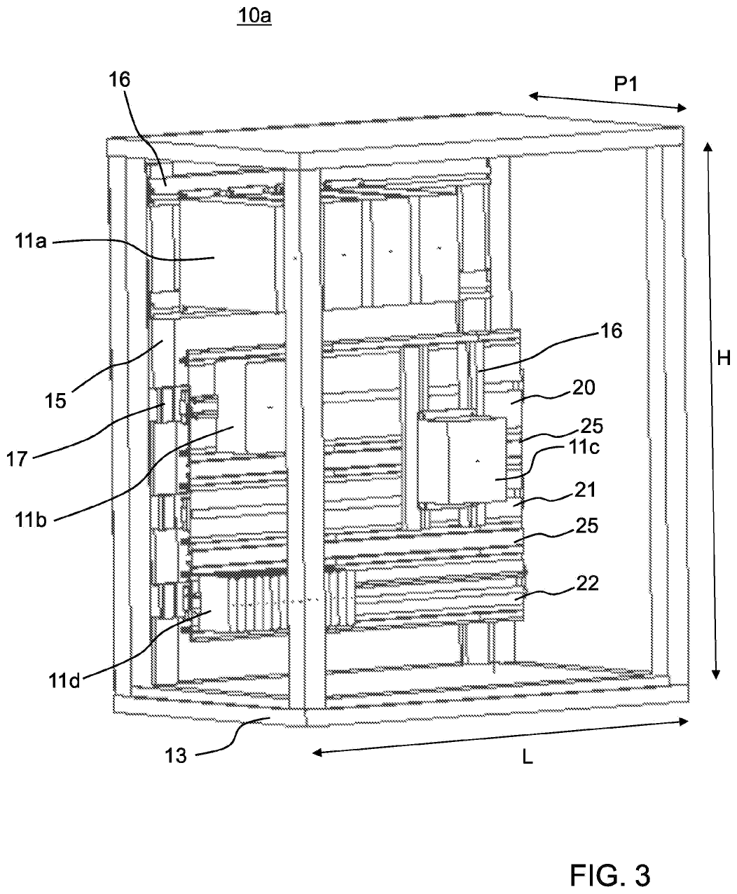

The following description presents a particularly simplified embodiment of the invention. Indeed, the four installations shown in FIGS. 3 to 6 aim only to describe a possible operation of the method of the invention. Such that the modifications can be explained, the number and the type of electrical components have been limited. Of course, in a real installation, the number and the diversity of electrical components is often much greater.

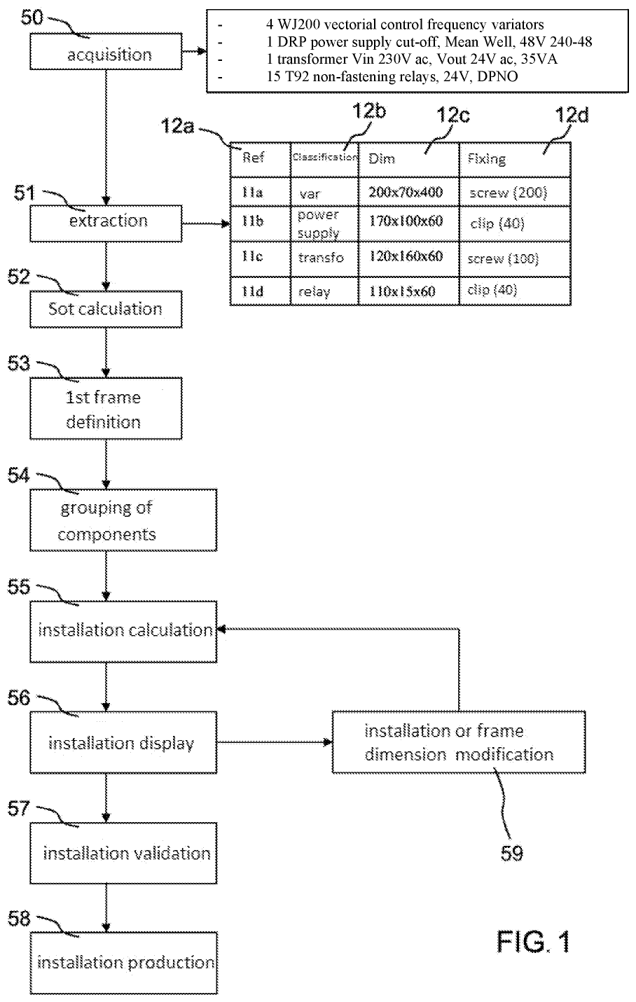

In the example of FIG. 1, a first step 50 consists of acquiring a list of electrical components selected to be integrated in an industrial electrical cabinet. In general, this list of equipment is provided by the end user of the industrial electrical cabinet.

In the example of FIG. 1, the list is particularly simple since it comprises four vector-controlled frequency variators; a switched-mode power supply; a 230/24V transformer; and fifteen 24V non-fastening relays. These elements only aim to illustrate one example of an embodiment and, of course, numerous other electrical components may be installed with the method of the invention.

Following this first step 50 of acquiring the list of electrical components intended to be installed in an industrial electrical cabinet, the method then comprises a second step 51 aimed at finding and extracting a representation and technical information associated with each electrical component selected in step 50.

For each electrical component, this step 51 preferably uses a local or remote database to find a representation in two or three dimensions of the electrical component. Furthermore, the technical information associated with each electrical component is entered in a table comprising at least four columns: a first column 12a indicating the reference of each electrical component, for example 11a to 11d; a second column 12b indicating a classification of each electrical component; a third column 12c presenting the dimensions of each electrical component; and a fourth column 12d containing fixing information. This fixing information aims to describe the means for fixing each electrical component on a support structure. For example, the electrical components 11a-11d may be fixed by clipping or by screwing and the distance between the axes of the screws or of the clips may vary from one component to another.

In the example of FIG. 1, the four variators 11a as well as the transformer 11c are fixed by screws. The variators 11a have a centre distance of 200 mm, while the transformer 11c has a centre distance of 100 mm. Furthermore, the power supply 11b and the relays 11d are fixed by a clipping system to a DIN rail in the form of an omega with a centre distance of 35 mm between the two legs of the omega.

Following this extraction of the representation and of the technical information 12a-12d, a step 52 automatically calculates the total occupancy area Sot of the electrical components 11a-11d depending on the sum of the surface area in height and in width of the different electrical components 11a-11d. Furthermore, this step 52 can also seek a minimum depth depending on the deepest depth of the electrical components 11a-11d.

In the example in FIG. 1, the deepest of the electrical components 11a-11d are the variators 11a, having a depth of 400 mm. A first frame 13 with a depth greater than 450 mm can therefore be defined, in a step 53, while taking account of the minimum depth of the support elements. With this depth constraint, the height H and the width L of the first frame 13 are determined depending on total occupancy area Sot of the electrical components 11a-11d with the application of a multiplying coefficient to this total occupancy area Sot in order to limit the installation constraints and to provide the necessary reserves for the wiring. For example, the multiplier coefficient may be between 1.2 and 1.5. Thus, a first frame 13, the size of which is the smallest and which satisfies the requirements previously described, is created automatically, in this step 53, from structural elements such as uprights, cross-members, bottom plates, facades, cable troughs, etc., the various types of which are predefined in a local or remote database. The term “creation of a frame” means a virtualisation or a modelling of said frame.

Such as illustrated in FIG. 3, this first frame 13 comprises four uprights connecting two upper and lower plates. During the production of the industrial electrical cabinet, side plates are also added, and a front facade generally has a door, making it possible to work on the electrical components installed in the industrial electrical cabinet. In certain cases, the industrial electrical cabinet may also comprise a bottom plate. Further to the uprights forming the structure of the first frame 13, this frame 13 also incorporates two vertically extending support uprights 15, juxtaposed with the uprights making it possible to connect the upper and lower plates. The electrical components 11a-11d of the industrial electrical cabinet are mounted on these support uprights 15.

In order to determine the installation strategy of the electrical components 11a-11d, the method of FIG. 1 continues, in a step 54, by an automatic grouping of the electrical components 11a-11d having similar functions and fixing means. The similarity of the fixing means is fairly simple to obtain since it is appropriate to group together the electrical components 11a-11d which have the same fixing means described in column 12d of the table obtained by the extraction step 51. Thus, it is possible to group the electrical component 11b and the electrical components 11d together since they are all intended to be mounted on a DIN rail by clipping with a centre distance of 35 mm.

However, these components 11b and 11d cannot be grouped together because it is preferable to group together the electrical components of the same function so as to obtain an industrial electrical cabinet wherein several zones are intended for distinct functions.

For example, it is possible to classify electrical components according to four main functions: power, protection, control and connection. The power function is mainly provided by the main disconnector receiving the mains supply, the power supplies, the transformers and the variators. The protection function integrates in particular the circuit breakers and fuse holders. The control function includes PLCs and relays while the connection function integrates terminal blocks and interfaces.

In the example of FIG. 1, the electrical components 11a-11c can be classified in the power function and the electrical components 11d can be classified in the control function. The components 11b and 11d are therefore dissociated.

When the electrical components 11a-11d are grouped together, it is possible to automatically calculate a first installation 10a, in a step 55. There are a large number of possible rules making it possible to calculate this first installation 10a.

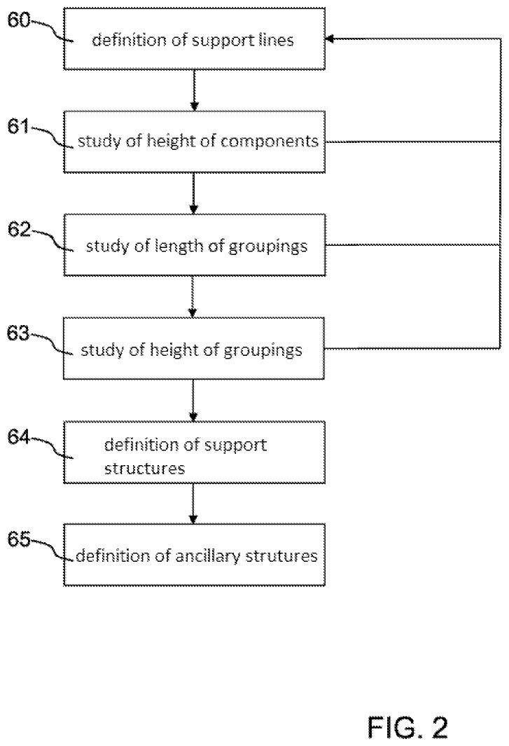

For example, such as illustrated in FIG. 2, a first step 60 consists of defining the lines making it possible to support the different groupings carried out. In a first definition, each grouping is superposed in the height H of the frame 13. The support of each grouping is preferably provided by one or two profiles fixed by stirrups 17, mounted on the uprights 15.

A second step 61 aims to verify that the considered installation complies with the depth constraints of the frame 13. In the example of FIG. 1, the components 11a cannot be mounted on profiles fixed on stirrups 17 as this installation would exceed the depth of the frame 13. With this information, the method returns to step 60 and the components 11a are mounted on rails 16 directly fixed to the uprights 15, i.e. without a stirrup 17.

This strategy for installing the components 11a makes it possible to pass step 61 and arrive at step 62 wherein the length dimensions of the groupings are verified. This verification aims to check if the dimensions of the components of a grouping require several superposed lines. In the example of FIG. 1, it is not necessary to modify the installation because the width L of the frame 13 is sufficient to integrate all the groupings on one single line.

The third verification, carried out in a step 63, concerns compliance with the height H of the frame 13 in order to integrate all the groupings. In this step 63, it must be mentioned that the dimensions of the electrical components 11a-11d can be used directly according to the dimensions present in column 12c of the table of FIG. 1.

In a variant, it is possible to take additional considerations into account in anticipating the wiring of the electrical components 11a-11d. Typically, the electrical component 11c is a particular component that requires additional height space to enable wiring to take place.

Thus, in this step 63, the height of the component 11c corresponds to the height of 120 mm added to a height allowing wiring, for example a predetermined height of 40 mm.

The study of the height of the installation considered in step 63 indicates that the groupings exceed the height H of the frame 13. It is therefore sought, in step 60, to shift a grouping in the width L of the frame 13 in order to arrange it on the same line as another component. Given the remaining width on the line of components 11a, step 60 converges towards a solution wherein the component 11c is arranged on the same line as the component 11b.

When steps 61 to 63 have been passed successfully, the installation of the components is known and the support structures remain to be defined, in a step 64.

For the first line, such as illustrated in FIG. 3, step 64 selects two rails 16 mounted parallel on the support uprights 15 with a distance of 200 mm.

For the second line, step 64 selects a profile 20 intended to receive both the component 11b and the component 11c. The profile 20 has a height of 155 mm adapted to the height of the electrical component 11b. Given the height required to install the electrical component 11c while integrating the wiring constraints, a second profile 21 is arranged under the profile 20 and the component 11c is mounted on two rails 16 aimed at on the two profiles 20 and 21. In a variant, it would have been possible to use one single profile with a greater height to receive the two components 11b and 11c, but the use of two distinct profiles 20-21 makes it possible to create a line under the component 11b on which the components can subsequently be installed. Thus, step 64 preferably seeks to use profiles of which the height is less than 200 mm.

The profile 21 has a flat surface, while the profile 20 has a right part with a flat surface and a left part provided with a central omega DIN rail for clipping the electrical component 11b. Finally, step 64 selects a profile 22 also having an omega DIN rail but a height of 95 mm adapted to the height of the electrical components 11d.

From these different searches, the method of FIG. 2 makes it possible to automatically determine the position of each electrical component 11a-11d, the positions and the dimensions of each support structure and the number of stirrups 17 necessary for mounting the profiles 20-22.

Furthermore, in a final step 65, the ancillary structures are defined, i.e. the structures which can be selected without requiring a modification of the installation of the electrical components 11a-11d and of the support structures. In the example of FIG. 3, the ancillary structures may correspond to the covers 25 arranged between the profiles 20-22. The different types of support structures and ancillary structures are also predefined in a database.

Following this step of calculating 55 a first installation 10a, the method illustrated in FIG. 1 presents a step 56 intended to display this first installation 10a. It is possible to directly validate, in a step 57, this first installation 10a and to proceed to a final step 58 of carrying out the installation in order to actually mount the industrial electrical cabinet thus designed. This production step possibly involves the control of the electrical components 11a-11d, the control and the cutting of the support elements and the mounting of these elements to form the industrial electrical cabinet.

In a variant, according to the invention, the method of FIG. 1 makes it possible to modify the position of one or more electrical components 11a-11d and/or the dimensions of the frame 13, in a step 59, so as to reperform in real time and dynamically, the calculation, in step 55, depending on these new constraints. These new constraints may involve a new organisation of the support elements, new dimensions of the frame, etc. This step 59 may be carried out one or more times depending on the number of modifications requested. Each modification forms the subject of an automatic processing in a software loop formed by steps 59, 56 and 57 which make it possible to display dynamically and with each new modification, a new installation and/or a new frame. This dynamic operation allows the user to view in real time the impact of each requested modification. In the sense of the invention, the term “in dynamic mode” indicates that the computer on which the method is implemented is configured to display the modifications made quickly or in real time. Typically, the modifications can be displayed in less than a second such that the user does not feel any latency and can test a large number of construction scenarios of an industrial cabinet.

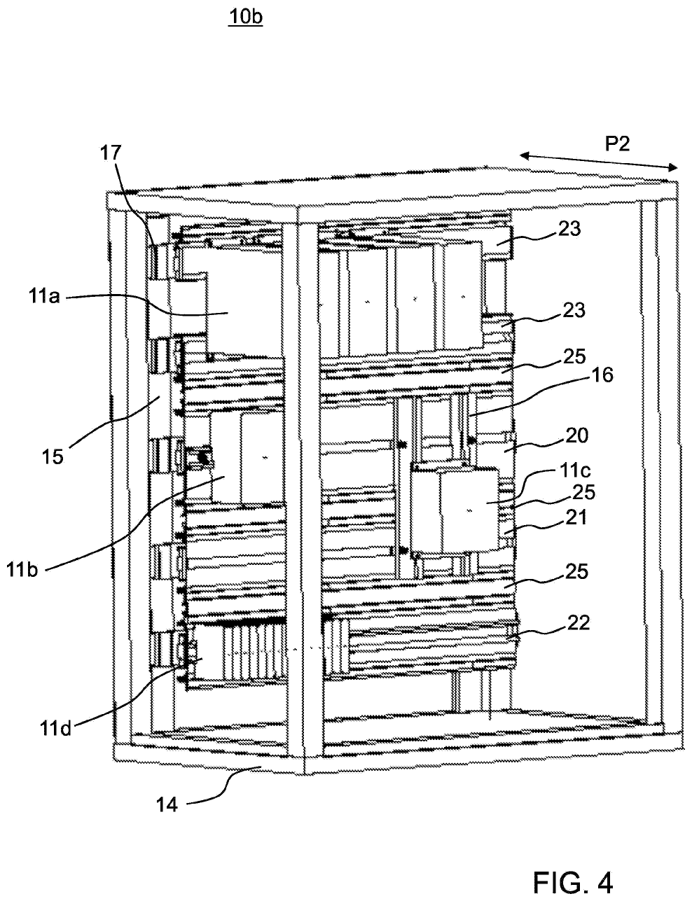

FIGS. 4 to 6 illustrate examples of modifications carried out by the user.

A first modification carried out by the user consists of specifying the depth of the frame 13 by applying a depth P2 of 600 mm instead of a depth P1 of 500 mm, which makes it possible to obtain a new frame 14. Such as illustrated in FIG. 4, this modification allows the electrical components 11a to be mounted on profiles 23, themselves mounted on stirrups 17.

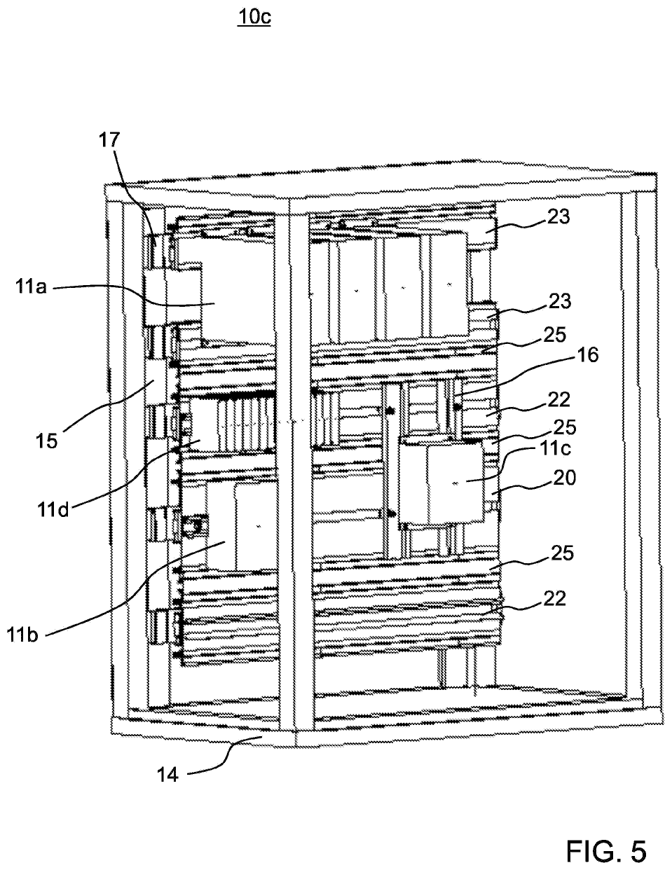

Step 61 of FIG. 2 now considers that the component 11a can be mounted on stirrups 17 and a special profile 23 is mounted to accept the screwing of the electrical components 11a on the first line of the installation 10b. A second modification is carried out by the user by fixing the position of the electrical components 11d above the electrical component 11b. Such as illustrated in FIG. 5, with this installation constraint, the method of FIG. 2 arranges the electrical components 11d on a dedicated line between the electrical components 11a and 11b.

Furthermore, in this installation 10c, the electrical component 11c is mounted on the profiles 20 and 22 for mounting the electrical components 11d and 11b such that the lower line can be removed and the height H of the new frame 14 can be reduced.

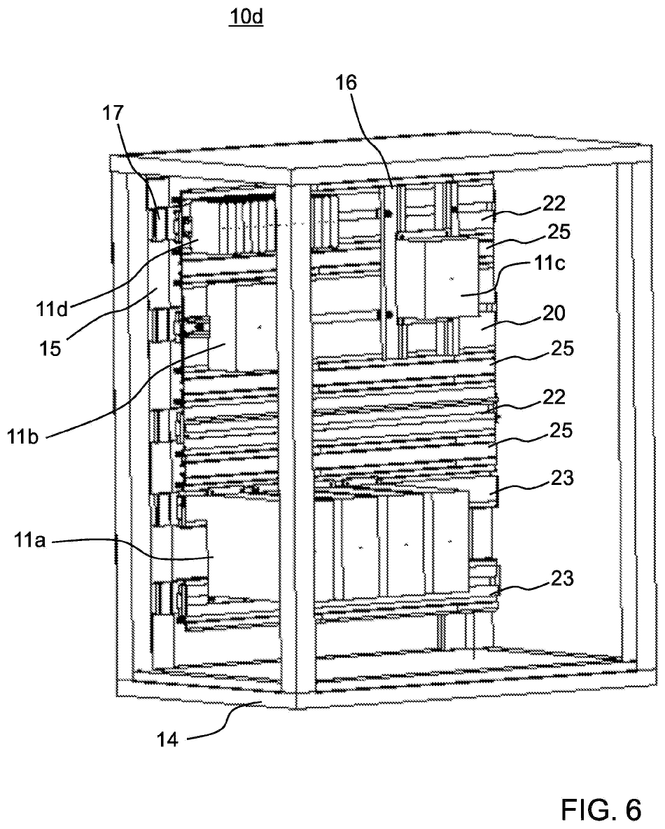

A third modification consists of arranging the electrical components 11a level with the lower line. Such as illustrated in FIG. 6, this third modification makes it possible to obtain an installation 10d that is very different from the first installation 10a and adapted to the needs of the user.

The invention thus makes it possible to modify the dimensions of the frame easily and dynamically and the installation of electrical components 11a-11d in the design of an industrial electrical cabinet. Preferably, these modification possibilities are accessible from an interface of a software representing the installation 10a-10d. This interface may be accessible on a computing device such as a computer, touchpad, or smartphone. This interface can be generated directly by an application installed on the user's device or hosted on a remote server. In any case, the calculations necessary to apply the constraints of the user consume material resources and the display of elements in three dimensions is often long.

To reduce these display constraints, the extraction step 51 preferably performs a transformation of the representation into the FBX format and then into the AssetBundle format when the interface is generated by a remote server.

The invention thus makes it possible to obtain a fluid interface accessible via the internet on a computing device such as a computer, a touchpad or a smartphone, in order to represent the electrical components 11a-11d and their supports. It also makes it possible to obtain a quick and dynamic response during the carrying out of the steps of the method, and to display any new installation and/or any new frame in real time, without latency, hence an ergonomics of use and an assessable saving of time.

1. A method for producing an industrial electrical cabinet depending on a list of electrical components, characterised in that said method is implemented by computer and comprises, in order, the following steps:
extraction of a representation and technical information associated with each electrical component, said technical information integrating at least one classification of said electrical component, a size of said electrical component and fixing information describing means for fixing said electrical component;
calculation of a total occupancy area of said electrical components as a function of said size of each electrical component;
definition of a first frame as a function of said total occupancy surface;
grouping of said electrical components according to said classification and said fixing information of each electrical component;
calculation of a first installation wherein said grouped electrical components are juxtaposed and said remaining electrical components are iteratively arranged in the free spaces of the first frame;
displaying the first installation with means for modifying the installation of each electrical component and/or the dimensions of the first frame;
for each modification carried out, calculating and displaying in dynamic mode, of a new installation and/or a new frame depending on the constraints applied by the user; and
production of an industrial electrical cabinet depending on said resulting obtained installation and/or said new frame.

2. The method for producing an industrial electrical cabinet according to claim 1, wherein said step of extracting a representation and technical information associated with each electrical component performs a transformation of a three-dimensional representation of each electrical component into a FBX format such that the displaying of the installations is done in three dimensions.

3. The method for producing an industrial electrical cabinet according to claim 1, wherein said step of extracting a representation and technical information associated with each electrical component performs a transformation of a three-dimensional representation of each electrical component into an AssetBundle format so that the displaying of the installations is done in three dimensions.

4. The method for producing an industrial electrical cabinet according to claim 1, wherein said technical information comprises only a reference of said electrical component, a classification of said electrical component, a size of said electrical component and fixing information describing fixing means of said electrical component.

5. The method for producing an industrial electrical cabinet according to claim 1, wherein said step of defining a first frame is carried out by creating a frame, a depth of which is greater than a maximum depth of the electrical components.

6. The method for producing an industrial electrical cabinet according to claim 1, wherein said step of defining a first frame depending on total occupancy area is carried out by creating a frame, an area of which is greater than the total occupancy area multiplied by a coefficient of between 1.2 and 1.5.

7. The method for producing an industrial electrical cabinet according to claim 1, wherein said step of grouping said electrical components is carried out according to four functions: securing, powering, controlling and interfacing one or more devices.

8. The method for producing an industrial electrical cabinet according to claim 1, wherein said calculation step seeks, firstly, to mount the electrical components grouped together on profiles mounted on stirrups themselves mounted on support uprights and, secondly, on rails mounted on support uprights

9. The method for producing an industrial electrical cabinet according to claim 1, wherein said step of defining a first frame depending on total occupancy area is carried out by creating a frame, an area of which is greater than the total occupancy area multiplied by a coefficient of 1.3.
